(19) United States
(12) Patent Application Publication
(10) Pub. No.: US 2008/0222815 A1
(43) Pub. Date: Sep. 18, 2008

(54) Multifunction container piercing tool

(76) Inventors: John T. Yurek, Hayden, ID (US); David Millar, Aliso Viejo, CA (US)

Correspondence Address: LUMEN PATENT FIRM, INC., 2345 YALE STREET, SECOND FLOOR, PALO ALTO, CA, 94306, US

(21) Appl. No.: 12/074,717

(22) Filed: Mar. 4, 2008

Related U.S. Application Data
(60) Provisional application No. 60/918,167, filed on Mar. 14, 2007.

(51) Int. Cl. B26B 11/00

(52) U.S. Cl. 7/161

(57) ABSTRACT

A multifunction container-piercing tool is provided. The tool includes a base and a piercing element having a pointed tip and a triangle base. The triangle base is attached to the front of the base. A hook is connected to the bottom of the base. The hook base extends from the bottom of the tool base and the catch faces toward the pointed tip. The distance between the catch and the base is about equal to the length of the piercing element. A handle extends from the back of the base, where the handle has at least one fork element. The fork element is disposed to leverage a mass of turf, such as a divot in a putting green. The hook pivots about a container bottom, and the piercing element provides an opening in a beverage can sidewall to enable rapid delivery of the contents when the pull-tab is lifted.

### FIELD OF THE INVENTION

The invention relates generally to multi purpose openers. More particularly, the invention relates to a multifunction beverage can piercing tool for rapid dispensing of the beverage.

### BACKGROUND

There exists a desire among consumers to deploy beverages at an accelerate rate. Typically, drinking a beverage is impeded by a reduction in air pressure within a beverage can as the liquid is dispensed, thus creating a vacuum-effect that pulls air from outside to inside the container thereby intermittently blocking the flow of the liquid from the can. It is often desirable to rapidly consume beverages while engaging in outdoor activities, such as golf for example. Accordingly, there is a need to develop a device that enables rapid delivery of beverage contents by eliminating the vacuum impedance, while providing other useful features commensurate with activities commonly associated with beverage consumption.

### SUMMARY OF THE INVENTION

To address the shortcomings in the art, a multifunction container-piercing tool is provided. The current invention includes a base and a piercing element, where the piercing element has a generally triangular shape with a pointed tip and a triangle base. The triangle base is attached to a front end of the base. The invention further includes at least one hook connected to a bottom of the base, where the hook includes a hook base and a hook catch. The hook base extends from the bottom of the base and the catch faces generally toward the pointed tip. The distance between the catch and the base is about equal to a length of the piercing element. A handle extends from a back end of the base, where the handle has at least one fork element. The fork element is disposed to leverage a mass of turf, such as a divot in a putting green.

In one embodiment of the invention, the base has a base top surface that has a magnet incorporated thereon. The magnet is disposed to magnetically attach to a generally planar ferric element. According to one embodiment, the base top surface further includes a cavity having a cavity edge, where the cavity edge is disposed to provide a fulcrum to the ferric element when an end of the ferric element is depressed into the cavity, thereby an end of the ferric element is pivoted away from the base top surface for removal there from.

In one aspect of the invention, the fork element extends at an angle relative to the top base surface. The fork element angle can have a range from 90 to 270 degrees.

In another aspect of the invention, the piercing element projects downward from the top base surface. The downward projection can be a curved projection and/or an angled projection. The angled projection can have a range between 90 and 180 degrees.

In another aspect of the invention, the top base surface further includes a thumb-grip depression therein.

In yet another aspect of the invention, the piercing tool can be made from material such as aluminum, steel, zinc, plastic, fiber-filled plastic, stainless steel, alloy metals and cast metals.

In one aspect of the invention, the hook, the base and the piercing element form a generally C-shape cross-section, where a cylindrical object may be fittedly inserted therein.

In a further aspect of the invention, the fork element has a fork tip end, where the tip end is sized to fit within a groove of a striking surface of a golf club head.

### BRIEF DESCRIPTION OF THE FIGURES

The objectives and advantages of the present invention will be understood by reading the following detailed description in conjunction with the drawing, in which:

FIGS. 1a-1d show perspective and planar views of one embodiment of the multifunction beverage opener and divot tool according to the present invention.

FIGS. 2a-2e show the steps of using the beverage opener aspect of the present invention.

FIGS. 3a-3b show perspective views of the multifunction beverage opener and divot tool with ball marker according to the present invention.

FIGS. 4a-4f show perspective views of different embodiments of the multifunction beverage opener according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

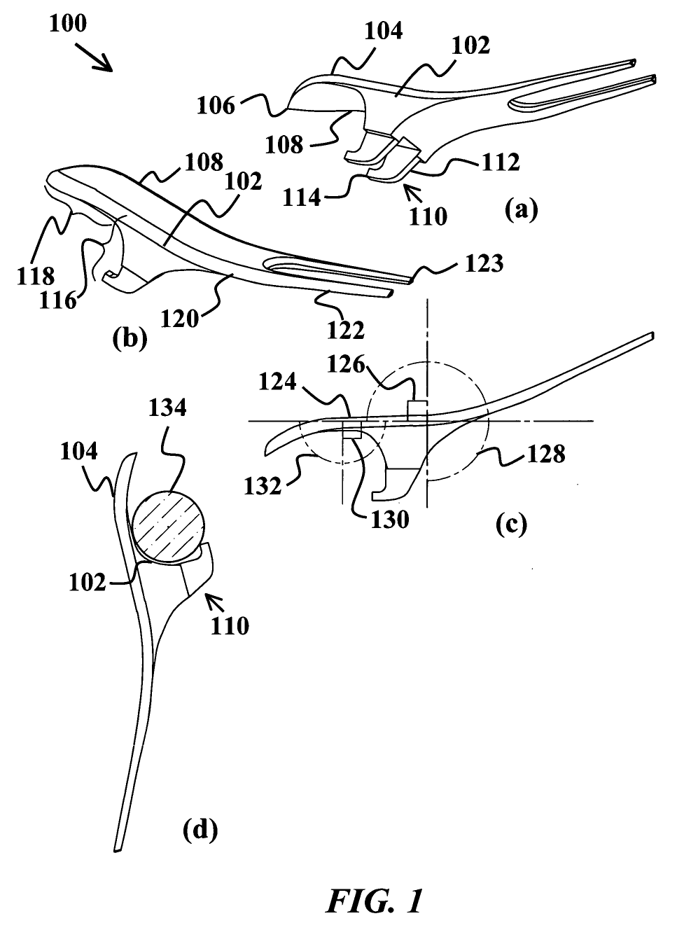

FIGS. 1a-1d show perspective and planar views of a multifunction beverage opener and golf divot tool 100. FIG. 1a is a bottom perspective view and FIG. 1b is a top perspective view showing a multifunction container-piercing tool 100 according to the current invention. The tool 100 includes a base 102 and a piercing element 104, where the element has a generally triangular shape with a pointed tip 106 and a triangle base 108. The triangle base 108 is attached to a front end of the base 102. Further shown is at least one hook 110 connected to a bottom of the base 102, where the hook 110 includes a hook base 112 and a hook catch 114. The hook base 112 extends from the bottom of the base 102 and the catch 114 faces generally toward the pointed tip 106. FIG. 1b shows the distance 116 between the catch 114 and the base 102 is about equal to a length 118 of the piercing element 104. A handle 120 extends from a back end of the base 102, where the handle 120 has at least one fork element 122. The fork element 122 is disposed to leverage a mass of turf (not shown), such as a divot in a putting green. According to one aspect of the current embodiment, the fork element 122 has a fork tip 123, where tip 123 is sized to fit within a groove of a striking surface of a golf club head (not shown), thus enabling cleaning therein.

FIGS. 1c-1d show planar views of one embodiment of the multifunction beverage opener and golf divot tool 100. In one aspect of the invention, the fork element extends 122 at an angle relative to the top base surface 124 that can have a range from approximately a right angle 126 to about 270 degrees 128. In another aspect of the invention, the piercing element projects downward from the top base surface. The downward projection can be a curved projection and/or an angled projection. The angled projection can have a range between about a right angle 130 and 180 degrees 132. In another aspect of the invention, the hook 110, the base 102 and the piercing element 104 form a generally C-shape cross-section, as shown in FIG. 1d, where a cylindrical object 134 may be fittedly inserted therein when the fork element 122 is inserted about vertically into soft material such as turf (not shown), thereby elevating the cylindrical object 134 above the ground. For example, the cylindrical object 134 may be a cigar or a golf club handle (not shown).

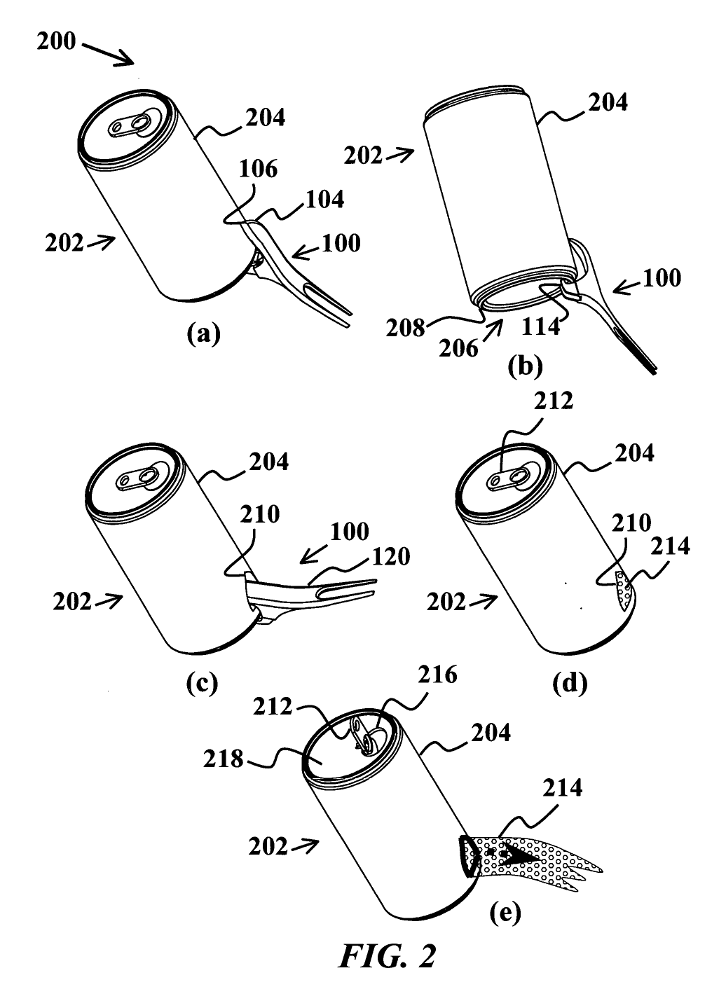

FIGS. 2a-2e are perspective views showing the steps 200 of using the beverage opener aspect of the multifunction beverage opener and golf tool 100. Shown is a beverage can 202 with the multifunction beverage opener 100 with the piercing tip 106 of the piercing element 104 being disposed against the can sidewall 204. FIG. 2b shows a bottom oblique view of the configuration described for FIG. 2a with the hook 110 disposed at the can bottom 206 and the hook catch 114 fitting around the can bottom rim 208. Here, the can bottom rim provides a fulcrum for the opener 100 to pivot about when an upward force is applied to the handle 120. FIG. 2c shows the opener 100 being rotated and the piercing tip provides an opening 210 in the can sidewall 204. FIG. 2d shows the opening 210 with the multifunction piercing tool 100 removed. Here, the pull-tab 212 is in an unopened state. In the unopened state, the liquid content 214 of the can 202 is held within the can due to a vacuum effect within the can 202. Left undisturbed, the liquid will generally remain in the can 202 until the pull-tab 212 is lifted to open the can 202 as per the beverage can design. FIG. 2e shows the beverage can 202 having the pull-tab 212 in an open state, where the pull-tab 212 is pivoted to provide a top opening 216 in the can top 218 and the liquid content 214 is rapidly dispensed when the vacuum effect is removed.

According to one aspect of the invention, the multifunction piercing tool 100 can be made from material such as aluminum, steel, zinc, plastic, fiber-filled plastic, stainless steel, alloy metals and cast metals.

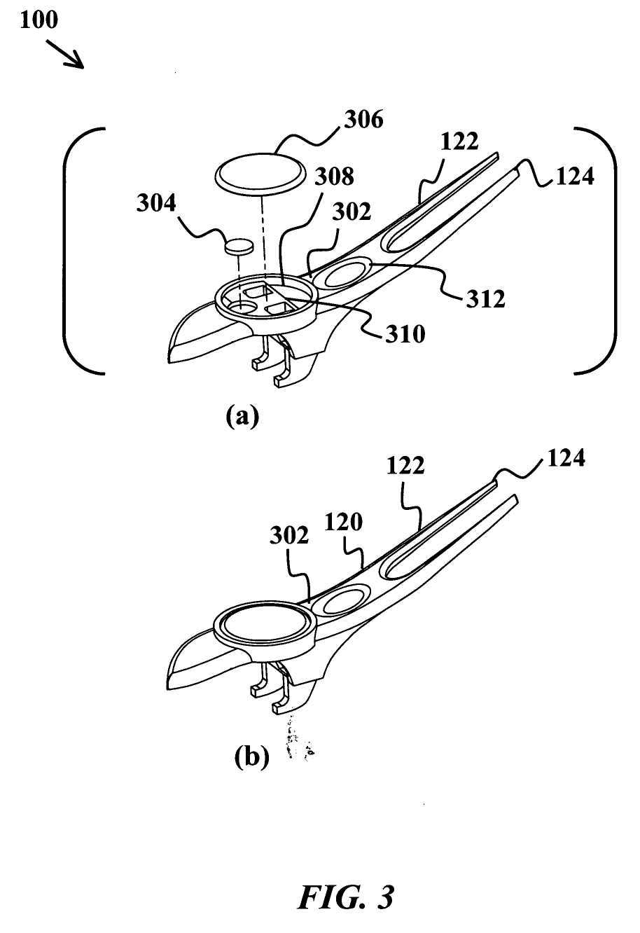

FIGS. 3a-3b show an alternate embodiment of the multifunction beverage opener and golf divot tool 100, where FIG. 3a shows an exploded perspective view and FIG. 3b shows an assembled perspective view. In the exploded perspective view of FIG. 3a, the base 102 is shown having base top surface 302 with a magnet 304 incorporated thereon. The magnet 304 is disposed to magnetically attach to a generally planar ferric element 306. The base top surface 302 further includes a cavity 308 having a cavity edge 310, where the cavity edge 310 is disposed to provide a fulcrum to the ferric element 306. When an end of the ferric element 306 is depressed into the cavity 310, the ferric element 306 is pivoted away from the base top surface 302 for removal. The generally planar ferric element 306 can be used as a golf ball marker on a putting green (not shown) when it is removed from the top surface 302. Further shown in FIGS. 3a and 3b, the top base surface 302 further includes a thumb-grip depression 312 for comfortable handling and use. The handle has 120 least one fork element 122. The fork element 122 is disposed to leverage a mass of turf (not shown), such as a divot in a putting green. According to one aspect of the current embodiment, the fork element 122 has a fork tip 124 sized to fit within a groove of a striking surface of a golf club head (not shown), thus enabling cleaning therein.

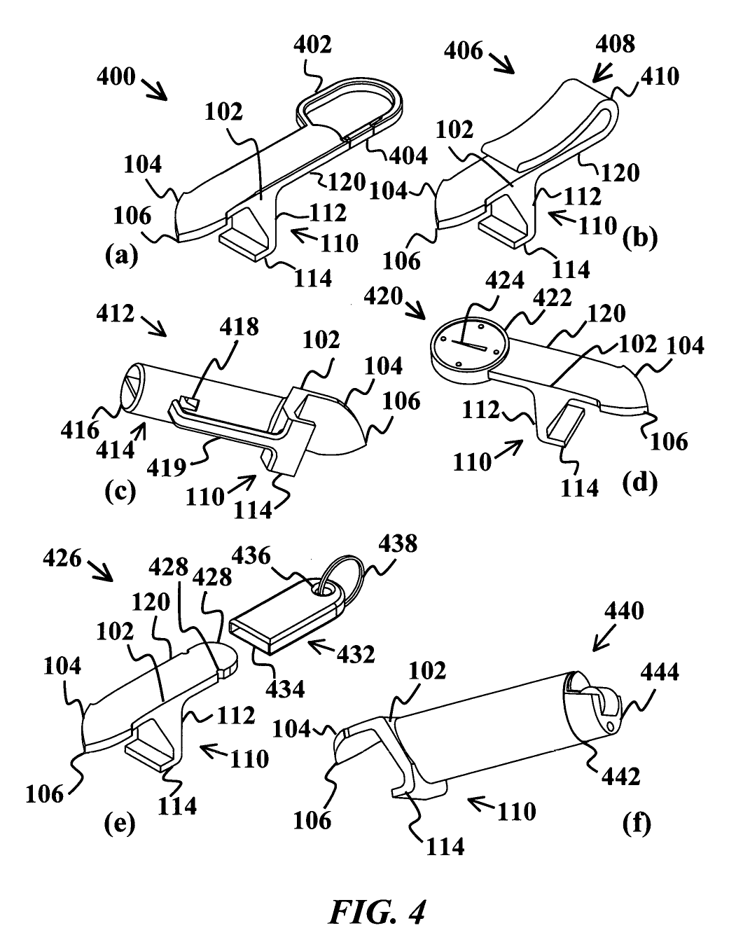

FIGS. 4a-4e show different embodiments of the current invention. FIG. 4a shows a multifunction beverage opener and carabiner tool 400. As shown, the carabiner tool 400 includes a base 102 and a piercing element 104, where the element has a generally triangular shape with a pointed tip 106 and a triangle base 108. The triangle base 108 is attached to a front end of the base 102. Further shown is at least one hook 110 connected to a bottom of the base 102, where the hook 110 includes a hook base 112 and a hook catch 114. The hook base 112 extends from the bottom of the base 102, and the catch 114 faces generally toward the pointed tip 106. The distance between the catch 114 and the bottom of the base 102 is about equal to the length of the piercing element 104 (see FIG. 1b). A handle 120 extends from a back end of the base 102, where the handle 120 has a carabiner 402 incorporated thereto. The carabiner 402 is a loop with a sprung gate 404, where the gate may also be a screwed gate (not shown). The carabiner 402 can quickly and reversibly connect to many common components.

FIG. 4b shows a multifunction beverage opener and money clip tool 406. As shown, the money clip tool 406 includes a base 102 and a piercing element 104, where the element has a generally triangular shape with a pointed tip 106 and a triangle base 108. The triangle base 108 is attached to a front end of the base 102. Further shown is at least one hook 110 connected to a bottom of the base 102, where the hook 110 includes a hook base 112 and a hook catch 114. The hook base 112 extends from the bottom of the base 102, and the catch 114 faces generally toward the pointed tip 106. The distance between the catch 114 and the bottom of the base 102 is about equal to the length of the piercing element 104 (see FIG. 1b). A handle 120 extends from a back end of the base 102, where the handle 120 has a shape-memory element 408 that provides a spring actuated pinching-effect with the top surface of the handle 120, useful as a money clip. The money clip tool 406 has a looped end 410 that folds the shape-memory element 408 back onto itself to generate the pinching-effect for holding money and other important items therein.

FIG. 4c shows a multifunction beverage opener and whistle tool 412. As shown, the whistle tool 412 includes a base 102 and a piercing element 104, where the element has a generally triangular shape with a pointed tip 106 and a triangle base 108. The triangle base 108 is attached to a front end of the base 102. Further shown is at least one hook 110 connected to a bottom of the base 102, where the hook 110 includes a hook base 112 and a hook catch 114. The hook base 112 extends from the bottom of the base 102, and the catch 114 faces generally toward the pointed tip 106. The distance between the catch 114 and the bottom of the base 102 is about equal to the length of the piercing element 104 (see FIG. 1b). A handle 120 extends from a back end of the base 102, where the handle 120 has a whistle 414 incorporated therein. As shown, the whistle 414 includes an air input opening 416 and an air output opening 418, where a whistle sound is generated when air is passed through the input 416 to the output 418. The handle 120 further includes a loop 419, where the loop 419 is useful for attaching to key rings (not shown) and the like.

FIG. 4d shows a multifunction beverage opener and compass tool 420. As shown, the compass tool 420 includes a base 102 and a piercing element 104, where the element has a generally triangular shape with a pointed tip 106 and a triangle base 108. The triangle base 108 is attached to a front end of the base 102. Further shown is at least one hook 110 connected to a bottom of the base 102, where the hook 110 includes a hook base 112 and a hook catch 114. The hook base 112 extends from the bottom of the base 102, and the catch 114 faces generally toward the pointed tip 106. The distance between the catch 114 and the bottom of the base 102 is about equal to the length of the piercing element 104 (see FIG. 1b). A handle 120 extends from a back end of the base 102, where the handle 120 has a compass 422 incorporated thereto. As shown, the compass 422 includes a compass pointer 424 that is actuated according to the Earth's magnetic field (not shown).

FIG. 4e shows a multifunction beverage opener with a detachable keychain element tool 426. As shown, the detachable keychain element tool 426 includes a base 102, and a piercing element 104, where the element has a generally triangular shape with a pointed tip 106 and a triangle base 108. The triangle base 108 is attached to a front end of the base 102. Further shown is at least one hook 110 connected to a bottom of the base 102, where the hook 110 includes a hook base 112 and a hook catch 114. The hook base 112 extends from the bottom of the base 102 and the catch 114 faces generally toward the pointed tip 106. The distance between the catch 114 and the bottom of the base 102 is about equal to the length of the piercing element 104 (see FIG. 1b). A handle 120 extends from a back end of the base 102, where the handle 120 has an insert end 428 incorporated thereto. The insert end 428 has at least one engagement contour 430 disposed thereon, where the engagement contour facilitates engagement of the detachable keychain element 432. The detachable keychain element 432 includes a cavity 434 for receiving the insert end 428, where the cavity 434 includes an engagement protrusion (not shown) therein to engage the engagement contour 430 for detachably holding to the insert end 428. The keychain element 432 further includes a through hole 436 for receiving a ring 438 there through. The detachable keychain element tool 426 is very useful holding keys and the like (not shown) on the ring 438, while allowing the use opener without the attached keys when removed from the for allowing the detachable keychain element 432. It should be obvious that there are many useful ways to accomplish the detachable function of the current embodiment such as friction-fit, spring-clips and the like, where the embodiment in FIG. 4e is but one example.

FIG. 4f shows a multifunction beverage opener and a lighter holding tool 440. As shown, the detachable keychain element tool 426 includes a base 102 and a piercing element 104, where the element has a generally triangular shape with a pointed tip 106 and a triangle base 108. The triangle base 108 is attached to a front end of the base 102. Further shown is at least one hook 110 connected to a bottom of the base 102, where the hook 110 includes a hook base 112 and a hook catch 114. The hook base 112 extends from the bottom of the base 102, and the catch 114 faces generally toward the pointed tip 106. The distance between the catch 114 and the bottom of the base 102 is about equal to the length of the piercing element 104 (see FIG. 1b). A handle 120 extends from a back end of the base 102, where the handle 120 has lighter holder cavity 442 for holding a lighter 444 therein. The lighter 444 may be held by the cavity 442 using friction, adhesion or other similar methods, where the lighter 444 may be removed for replacement or refilling.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example the multifunction tool can be a combination of the opening tool and any combination of the embodiments described above. Further, the multifunction tool can include the opening tool in combination with other useful elements such as a ski pole holder, a flashlight, a surfboard wax scraper, a laser pointer, a lottery ticket scraper, utensil such as a fork, knife or spoon, a thermometer or a pen. It should be obvious that each of the embodiments and variations described above may be combined with any other embodiment described above.

All such variations are considered to be within the scope and spirit of the present invention as defined by the following claims and their legal equivalents.

What is claimed:

1. A multifunction container piercing tool comprising:
a. a base;
b. a piercing element, wherein said element comprises a generally triangular shape having a pointed tip and a triangle base, whereby said triangle base is attached to a front end of said base;
c. at least one hook connected to a bottom of said base, wherein said hook comprises a hook base and a hook catch, whereas said hook base extends from said base bottom and said catch is disposed to face generally toward said pointed tip, whereby a distance between said catch and said base is about equal to a length of said piercing element; and
d. a handle extending from a back end of said base, wherein said handle comprises at least one fork element, whereas said fork element is disposed to leverage a mass of turf.

2. The container piercing tool of claim 1, wherein said base comprises a base top surface, whereby said base top surface comprises a magnet incorporated thereon, whereas said magnet is disposed to magnetically attach to a generally planar ferric element.

3. The container piercing tool of claim 2, wherein said base top surface further comprises a cavity having a cavity edge, whereby said cavity edge is disposed to provide a fulcrum to said ferric element when an end of said ferric element is depressed into said cavity, whereas an end of said ferric element is pivoted away from said base top surface for removal there from.

4. The container piercing tool of claim 1, wherein said fork element extends at an angle relative to said top base surface.

5. The container piercing tool of claim 4, wherein said fork element angle has a range from 90 to 270 degrees.

6. The container piercing tool of claim 1, wherein said piercing element projects downward from said top base surface.

7. The container piercing tool of claim 6, wherein said downward projection is a curved projection and/or an angled projection.

8. The container piercing tool of claim 7, wherein said angled projection has a range between 90 and 180 degrees.

9. The container piercing tool of claim 1, wherein said top base surface further comprises a thumb-grip depression therein.

10. The container piercing tool of claim 1, wherein said piercing tool is made from material selected from a group consisting of aluminum, steel, zinc, plastic, fiber-filled plastic, stainless steel, alloy metals and cast metals.

11. The container piercing tool of claim 1, wherein said hook, said base and said piercing element form a generally C-shape cross section, whereby a cylindrical object fittedly inserts therein.

12. The container piercing tool of claim 1, wherein said fork element comprises a fork tip end, whereby said tip end is sized to fit within a groove of a striking surface of a golf club head.
